(19) United States
(12) Patent Application Publication
(10) Pub. No.: US 2015/0376298 A1
(43) Pub. Date: Dec. 31, 2015

(54) MODIFIED NANOCELLULOSE, AND RESIN COMPOSITION CONTAINING MODIFIED NANOCELLULOSE

(71) Applicants: DIC CORPORATION, Tokyo (JP); KYOTO UNIVERSITY, Kyoto (JP)

(72) Inventors: Fumiaki Nakatsubo, Uji-shi (JP); Haruo Omura, Uji-shi (JP); Hiroyuki Yanao, Uji-shi (JP)

(21) Appl. No.: 14/765,332

(22) PCT Filed: Jan. 31, 2014
(86) PCT No.: PCT/JP2014/052314

§ 371 Date: Aug. 1, 2015

(30) Foreign Application Priority Data
Feb. 1, 2013 (JP) 2013-018759

(51) Int. Cl. C08B 3/14; C08L 23/06; C08B 3/10; C08L 23/12

(52) U.S. Cl. CPC C08B 3/14; C08L 23/12; C08L 23/06; C08B 3/10

(57) ABSTRACT

The present invention provides a novel modified nanocellulose suitable for surface modification of nanocellulose or introduction of functional groups into nanocellulose, and a resin composition comprising the modified nanocellulose. More specifically, the present invention provides a modified nanocellulose in which a portion of the hydroxyl groups of cellulose constituting nanocellulose is substituted with at least one substituent represented by formula (1), and a resin composition comprising the modified nanocellulose and a resin.

### TECHNICAL FIELD

The present invention relates to a modified nanocellulose and a resin composition containing a modified nanocellulose.

### BACKGROUND ART

Cellulose fibers are a basic skeleton material of all plants, and more than one trillion tons of cellulose fibers are amassed on the earth. Cellulose fibers are one-fifth as light as steel but are five times stronger than steel with a linear thermal expansion coefficient being as low as 1/50 that of glass. Thus, the use of cellulose fibers by incorporating them as a filler in a matrix such as resin to impart mechanical strength seems promising (Patent Document 1). To further improve the mechanical strength of cellulose fibers, there have been attempts to produce cellulose nanofibers (CNF, microfibrils of plant fibers) from cellulose fibers through defibration (Patent Document 2). Further, cellulose nanocrystals (CNC) are also known as those obtained by defibrating cellulose fibers as with CNF.

CNF refers to fibers obtained by subjecting cellulose fibers to mechanical defibration. CNF has a fiber width of about 4 to 100 nm, and a fiber length of about 5 μm or more. CNC refers to crystals obtained by subjecting cellulose fibers to a chemical treatment, such as acid hydrolysis. CNC has a crystal width of about 10 to 50 nm, and a crystal length of about 500 nm. CNF and CNC are collectively referred to as nanocellulose. Nanocellulose has a high specific surface area (250 to 300 m²/g), and is lighter and stronger than steel.

Nanocellulose is less subject to thermal deformation than glass. Nanocellulose, which has high strength and low thermal expansion, is useful as a sustainable resource material. For example, the following materials have been developed and produced: composite materials or aerogel materials with high strength and low thermal expansion obtained by combining nanocellulose with polymeric materials such as resin; optical anisotropy materials using a chiral nematic liquid crystal phase driven by CNC self-assembly; and advanced functional materials obtained by introducing functional groups into nanocellulose.

Since nanocellulose is hydrophilic and strongly polar owing to an abundance of hydroxyl groups, nanocellulose is less compatible with generally-used, hydrophobic, and non-polar resins, such as rubber and polypropylene. Thus, material development using nanocellulose requires surface modification, or the introduction of functional groups into nanocellulose through optimal chemical treatment without losing the characteristics of cellulose as a material.

Conventional chemical treatments are performed with a solid-liquid heterogeneous system. Because nanocellulose is dissolved when subjected to such chemical treatments, the higher-order structure (crystal structure, etc.) of nanocellulose is susceptible to damage. Therefore, there is room for improvement in preventing the loss of the original physical properties of nanocellulose. Further, there is room for improvement in the conditions, such as the reaction rate, yield, and selectivity, of the conventional chemical treatments.

Patent Documents 3 and 4 disclose fiber composite materials comprising chemically modified cellulose fibers having a mean fiber diameter of about 2 to 200 nm and a matrix material. However, Patent Documents 3 and 4 disclose only acetyl, methacryloyl, and the like, as the functional group introduced into cellulose fibers by chemical modification, and thus there is still room for improvement in the reinforcement that cellulose fibers can provide to fiber composite materials. Patent Document 5 also discloses a resin composition comprising a thermoplastic resin and organic fibers. However, the organic fibers in Patent Document 5 are cellulose fibers (pulp), and there is still room for improvement in the reinforcement that cellulose fibers can provide to resin compositions.

Non-patent Document 1 discloses cellulose fibers that are chemically modified with dehydroabietic acid chloride. Non-patent Documents 2 to 4 disclose cellulose fibers that are chemically modified with pivalic acid chloride (pivaloyl chloride), adamantoyl chloride (1-adamantanecarbonyl chloride), mesitoyl chloride, cyclopentanecarbonyl chloride, or cyclohexanecarbonyl chloride. However, Non-patent Documents 1 to 4 are directed to cellulose fibers (pulp), and thus, there is still room for improvement in the reinforcement that cellulose fibers can provide to resin compositions.

### CITATION LIST

### Patent Document

Patent Document 1: JP2008-266630A

Patent Document 2: JP2011-213754A

Patent Document 3: Japanese Patent No. 4721186

Patent Document 4: JP2010-143992A

Patent Document 5: JP2007-056176A

### Non-Patent Document

Non-patent Document 1: Carbohydrate Research 346 (2011), 2024-2027
Non-patent Document 2: Cellulose (2011) 18:405-419
Non-patent Document 3: Cellulose (2007) 14:347-356
Non-patent Document 4: Chirality 16:309-313 (2004)

### SUMMARY OF INVENTION

### Technical Problem

An object of the present invention is to provide a novel modified nanocellulose suitable for surface modification of nanocellulose, or introduction of high functional groups into nanocellulose, and to provide a resin composition comprising the modified nanocellulose.

### Solution to Problem

The present inventors conducted extensive research to achieve the above object, and found that a modified nanocellulose represented by the following formula (1) is suitable for surface modification of nanocellulose or introduction of high functional groups into nanocellulose without the loss of the characteristics of nanocellulose as a material. The inventors also found that a resin composition comprising the modified nanocellulose represented by formula (1) shows high adhesion strength at the interfaces. The inventors further found that the resin composition can be sufficiently reinforced because of the nanocellulose content, and thereby exhibits improved tensile strength.

The present invention has been accomplished by further research on the basis of these findings.

The present invention provides the following modified nanocellulose, resin composition, and method for the production thereof.

Item 1. A modified nanocellulose wherein a portion of the hydroxyl groups of cellulose constituting nanocellulose is substituted with a (at least one) substituent represented by formula (1)

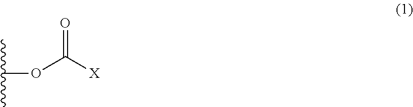

wherein X represents an alicyclic hydrocarbon group or a group including an alicyclic hydrocarbon group.
Item 2. The modified nanocellulose according to Item 1, which has a degree of ester substitution of 0.5 or less.
Item 3. A resin composition comprising:
a modified nanocellulose (A) wherein a portion of the hydroxyl groups of cellulose constituting nanocellulose is substituted with a (at least one) substituent represented by formula (1)

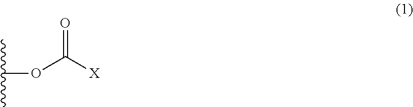

wherein X represents an alicyclic hydrocarbon group or a group including an alicyclic hydrocarbon group; and a resin (B).
Item 4. The resin composition according to Item 3, wherein the amount of the modified nanocellulose, calculated as the nanocellulose, is 0.5 to 150 parts by mass, per 100 parts by mass of the resin (B).
Item 5. The resin composition according to Item 3 or 4 wherein the resin (B) is a thermoplastic resin.
Item 6. A resin composition comprising:
a modified nanocellulose (A) wherein a portion of the hydroxyl groups of cellulose constituting nanocellulose is substituted with a (at least one) substituent represented by formula (1)

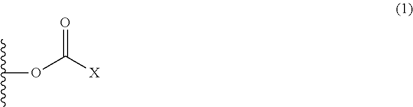

wherein X represents an alicyclic hydrocarbon group or a group including an alicyclic hydrocarbon group; and
a resin (B), the resin (B) in the resin composition being in the form of lamellae that are layered in a direction different from the fiber length direction of the modified nanocellulose (A).
   Item 7. The resin composition according to Item 6, comprising fibrous cores of the resin (B) that are uniaxially oriented in the fiber length direction of the modified nanocellulose (A), wherein the lamellae of the resin (B) are layered between the modified nanocellulose (A) and the fibrous cores in a direction different from the fiber length direction of the modified nanocellulose (A).
   Item 8. A resin molding material comprising the resin composition according to any one of Items 3 to 7.
   Item 9. A resin molded article obtained by molding the resin molding material according to Item 8.
   Item 10. A method for producing a modified nanocellulose wherein a portion of the hydroxyl groups of cellulose constituting nanocellulose is substituted with a (at least one) substituent represented by formula (1)

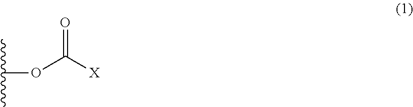

wherein X represents an alicyclic hydrocarbon group or a group including an alicyclic hydrocarbon group,
the method comprising modifying nanocellulose with a compound represented by formula (2)

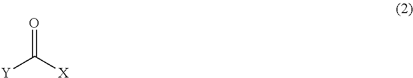

wherein X is as defined above; and Y represents halogen, hydroxy, alkoxy, or acyloxy.

### Advantageous Effects of Invention

In the modified nanocellulose according to the present invention, a portion of the hydroxyl groups of cellulose constituting nanocellulose is substituted with at least one substituent represented by formula (1). Thus, the modified nanocellulose is suitable for surface modification of nanocellulose without the loss of the characteristics of nanocellulose as a material. A resin composition comprising the modified nanocellulose represented by formula (1) shows high compatibility between the modified nanocellulose and the resin, and also shows high adhesion strength at the interfaces. Consequently, the resin composition can be sufficiently reinforced by the nanocellulose content, and thereby exhibits improved tensile strength.

Because the modified nanocellulose according to the present invention is obtained by modifying highly hydrophilic nanocellulose with a carboxylic acid having an alicyclic hydrocarbon group, the modified nanocellulose can be uniformly dispersed in a highly hydrophobic thermoplastic resin, particularly in polyethylene (PE) or polypropylene (PP). Accordingly, it is possible to obtain a composite material made of the modified nanocellulose and a resin, and a molded article thereof, showing enhanced interface adhesion between the modified nanocellulose and the resin, excellent strength, elastic modulus, heat resistance, and a linear thermal expansion coefficient as significantly low as an aluminum alloy. The modified nanocellulose according to the present invention can have a high reinforcing effect (tensile strength) especially on PP and add high elastic modulus especially to PP, which is normally difficult to reinforce by conventional chemically modified cellulose fibers.

Moreover, the resin composition according to the present invention is regularly structured such that lamellae of the resin are formed in the composition, and layered in a direction different from the fiber length direction of the modified nanocellulose. Thus, molded articles formed of the resin composition are excellent in mechanical strength.

### BRIEF DESCRIPTION OF DRAWINGS

FIG. 1 shows an X-ray CT scanned image of the resin molded article of Example 1 (bornyl phenoxyacetic acid CNF-PP).

FIG. 2 shows an X-ray CT scanned image of the resin molded article of Example 2 (adamantane carboxylic acid CNF-PP).

FIG. 3 shows an X-ray CT scanned image of the resin molded article of Example 3 (dehydroabietic acid CNF-PP).

FIG. 4 shows an X-ray CT scanned image of the resin molded article of Example 4 (tert-butylcyclohexane carboxylic acid CNF-PP).

FIG. 5 shows an X-ray CT scanned image of the resin molded article of Example 5 (cyclohexane carboxylic acid CNF-PP).

FIG. 6 shows an X-ray CT scanned image of pivaloyl CNF-PP.

FIG. 7 shows an X-ray CT scanned image of the resin molded article of Example 7 (bornyl phenoxyacetic acid CNF-PE).

FIG. 8 shows an X-ray CT scanned image of acetyl CNF-PE.

FIG. 9 shows a TEM image of the resin molded article of Example 7 (bornyl phenoxyacetic acid CNF-PE).

FIG. 10 shows a TEM image of a myristoyl CNF-PE molded article.

### DESCRIPTION OF EMBODIMENTS

The following describes a modified nanocellulose and a resin composition comprising the modified nanocellulose according to the present invention in detail.

### 1. Modified Nanocellulose

The modified nanocellulose according to the present invention has a structure in which a portion of the hydroxyl groups of cellulose constituting nanocellulose is substituted with a (at least one) substituent represented by formula (1):

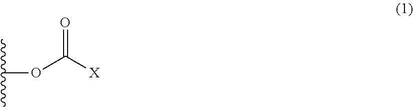

wherein X represents an alicyclic hydrocarbon group or a group including an alicyclic hydrocarbon group. In the modified nanocellulose according to the present invention, a portion of the hydroxyl groups of cellulose constituting nanocellulose is modified to include X as a functional group via an ester bond.

Examples of plant fibers used as a starting material for the modified nanocellulose include pulp obtained from natural plant materials, such as wood, bamboo, hemp, jute, kenaf, cotton, beets, agricultural waste, and cloth; and regenerated cellulose fibers, such as rayon and cellophane. Examples of wood include, but are not limited to, Sitka spruce, Cryptomeria japonica, Chamaecyparis obtusa, eucalyptus, and acacia. Examples of paper include, but are not limited to, deinked recycled waste-paper, cardboard recycled waste-paper, magazines, and copy paper. These plant fibers can be used singly or in a combination of two or more.

Of these, pulp or fibrillated cellulose obtained by fibrillating pulp is preferably used as a starting material. Preferable examples of pulp include chemical pulp (kraft pulp (KP) and sulfite pulp (SP)), semi-chemical pulp (SCP), chemiground pulp (CGP), chemi-mechanical pulp (CMP), ground pulp (GP), refiner mechanical pulp (RMP), thermomechanical pulp (TMP), and chemithermomechanical pulp (CTMP), which are obtained by chemically and/or mechanically pulping plant materials; and deinked recycled pulp, cardboard recycled pulp, and magazine recycled pulp, which comprise the above types of pulp as major components. These starting materials may optionally be subjected to delignification or bleaching to control the lignin content in the pulp.

Of these pulp types, various types of kraft pulp derived from softwood with high fiber strength (softwood unbleached kraft pulp (or “NUKP”), oxygen-prebleached softwood kraft pulp (or “NOKP”), and softwood bleached kraft pulp (or “NBKP”) are particularly preferably used.

Pulp consists mainly of cellulose, hemicellulose, and lignin. The lignin content of pulp is not particularly limited, and is typically about 0 to 40 wt %, and preferably about 0 to 10 wt %. The lignin content can be measured by using the Klason method.

In plant cell walls, a cellulose microfibril (single cellulose nanofiber) having a width of about 4 nm is present as the minimum unit. This is a basic skeleton material (basic element) of plants, and the assembly of these cellulose microfibrils forms a plant skeleton.

In the present invention, the term “nanocellulose” refers to cellulose nanofibers (CNF) or cellulose nanocrystals (CNC) obtained by breaking apart the fibers of a cellulose-fiber-containing material (e.g., wood pulp) to a nanosize level (defibrated).

CNF refers to fibers obtained by subjecting cellulose fibers to a treatment such as mechanical defibration, and CNF has a fiber width of about 4 to 200 nm, and a fiber length of about 5 μm. CNF has a specific surface area of about 70 to 300 m²/g, preferably about 70 to 250 m²/g, and more preferably about 100 to 200 m²/g. In a composition containing CNF and a resin, the larger the specific surface area of CNF, the larger the contact area; thus, the strength of the composition is increased. An excessively large specific surface area is likely to cause aggregation of CNF in the resin of the resin composition, and the desired high-strength materials may not be obtained. CNF typically has a mean fiber diameter of about 4 to 200 nm, preferably about 4 to 150 nm, and particularly preferably about 4 to 100 nm.

Examples of methods for defibrating plant fibers to prepare CNF include a method comprising the step of defibrating a cellulose-fiber-containing material such as pulp. For example, a defibration method can be used in which an aqueous suspension or slurry of the cellulose-fiber-containing material is mechanically milled or beaten using a refiner, a high-pressure homogenizer, a grinder, a single-screw or multi-screw extruder (preferably twin-screw extruder), a bead mill, or the like. These defibration methods may optionally be combined. For these defibration methods, JP2011-213754A and JP2011-195738A, for example, may be referred.

CNC refers to crystals obtained by subjecting cellulose fibers to a chemical treatment such as acid hydrolysis, and CNC has a crystal width of about 4 to 70 nm, and a crystal length of about 25 to 3,000 nm. CNC preferably has a specific surface area of about 90 to 900 m²/g, more preferably about 100 to 500 m²/g, and still more preferably about 100 to 300 m²/g. In a composition containing CNC and a resin, the larger the specific surface area of CNC, the larger the contact area; thus, the strength of the composition is increased. An excessively large specific surface area is likely to cause aggregation of CNC in the resin of the resin composition, and the desired high-strength materials may not be obtained. CNC typically has a mean crystal width of about 10 to 50 nm, preferably about 10 to 30 nm, and particularly preferably about 10 to 20 nm. CNC typically has a mean crystal length of about 500 nm, preferably about 100 to 500 nm, and particularly preferably about 100 to 200 nm.

To prepare CNC by defibrating plant fibers, a known method may be used. For example, a defibration method can be used in which an aqueous suspension or slurry of the aforementioned cellulose-fiber-containing material is subjected to a chemical treatment, such as acid hydrolysis using sulfuric acid, hydrochloric acid, or hydrobromic acid. These defibration methods may optionally be combined.

The mean fiber diameter of nanocellulose fiber (mean fiber diameter, mean fiber length, mean crystal width, and mean crystal length) is determined by measuring the fiber diameter of at least 50 modified nanocellulose fibers within the visual field of an electron microscope, and calculating the mean.

Nanocellulose has a high specific surface area (preferably about 200 to 300 m²/g), while being lighter and stronger than steel. Nanocellulose is also less subject to thermal deformation than glass (low thermal expansion).

The modified nanocellulose according to the present invention preferably has type-I cellulose crystalline structure, and the crystallinity is preferably as high as 50% or more. The crystallinity of type-I cellulose crystals of the modified nanocellulose is preferably 55% or more, and more preferably 60% or more. The maximum crystallinity of type-I cellulose crystals of the modified nanocellulose is typically about 95%, or about 90%.

Type-I cellulose crystalline structure is as defined by literature “Cellulose no Jiten” (published by Asakura Shoten, pages 81 to 86, or 93 to 99, new cover, first edition). Most natural cellulose has type-I cellulose crystalline structure. Cellulose fibers having type-II, type-III, or type IV cellulose crystalline structure are derived from cellulose having type-I cellulose crystalline structure. In particular, type-I crystalline structure shows a higher crystalline elastic modulus than the other structures.

In the present invention, it is preferable to prepare a modified nanocellulose by using nanocellulose that has type-I cellulose crystalline structure. Because of type-I crystals, a composite material comprising such nanocellulose and a matrix resin can have a low linear thermal expansion coefficient and high elastic modulus.

Nanocellulose having type-I crystalline structure can be identified by detecting typical peaks at two regions near 2θ=14 to 17° and near 2θ=22 to 23° in the diffraction profile obtained by wide-angle X-ray diffraction image analysis.

For example, ethanol is added to a slurry of nanocellulose or modified nanocellulose to adjust the nanocellulose concentration to 0.5 wt %. Subsequently, the slurry is stirred with a stirrer, and filtration under reduced pressure is quickly started (5C filter paper produced by Advantec Toyo). The obtained wet web is then subjected to compression heating at a temperature of 110° C. and at a pressure of 0.1 t for 10 minutes to thereby obtain a modified or unmodified CNF sheet (50 g/m²). The modified or unmodified CNF sheet is then measured to determine the crystallinity of the type-I cellulose crystals by using an X-ray generator (UltraX18HF produced by Rigaku Corporation) under the following conditions: a target of Cu/Kα line, a voltage of 40 kV, an electric current of 300 mA, a scan angle of (2θ) 5.0 to 40.0°, and a step angle of 0.02°.

In the modified nanocellulose according to the present invention, X in formula (1)

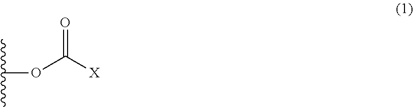

represents an alicyclic hydrocarbon group or a group including an alicyclic hydrocarbon group. The modified nanocellulose according to the present invention has at least one type of functional group X on the surface of the nanocellulose.

In formula (1), a carbonyl directly having an alicyclic hydrocarbon group is indicated as “X represents an alicyclic hydrocarbon group” and a carbonyl having an alicyclic hydrocarbon group via a linker is indicated as “X represents a group having an alicyclic hydrocarbon group.”

X may include alkylene, alkenylene, alkylene containing an aromatic ring, alkenylene containing an aromatic ring, cycloalkylene, or cycloalkenylene.

A linear or branched alkylene having 1 to 30 carbon atoms (—CₙH₂ₙ—) is preferable. Examples include methylene, ethylene, trimethylene, propylene, 2,2-dimethyl trimethylene, tetramethylen, pentamethylene, and hexamethylene. Alkylene having 1 to 18 carbon atoms is more preferable.

A linear or branched alkenylene having 2 to 30 carbon atoms is preferable. Examples include vinyl(ethenylene), allyl(propenylene), butenylene, pentenylene, and hexenylene. Alkenylene having 6 to 18 carbon atoms is more preferable.

X may further include a divalent aromatic ring. X may be alkylene having a divalent aromatic ring or alkenylene having a divalent aromatic ring. The divalent aromatic ring is a group formed by removing two hydrogen atoms attached to respective carbon atoms constituting the aromatic ring. Examples of aromatic rings include benzene ring (benzene rings), condensed benzene rings (naphthalene ring, pyrene ring, anthracene ring, biphenylene ring, etc.), non-benzene aromatic rings (tropylium ring, cyclopropenium ring, etc.), and heteroaromatic rings (pyridine ring, pyrimidine ring, pyrrole ring, thiophene ring, etc.).

X may include one or more unsaturated bonds, such as double bonds and triple bonds. X having a double bond as an unsaturated bond has a structural isomer of a cis- or trans-configuration, and both types of structural isomers can be used in the present invention without particular restriction.

X may include a structure formed by living polymerization of an olefinic monomer, styrenic monomer, and/or acrylic monomer (acrylic acid-based monomers, such as acrylic acid, allyl acrylate, ethyl acrylate, and methyl acrylate; and methacrylic acid based monomers, such as methacrylic acid, allyl methacrylate, ethyl methacrylate, glycidyl methacrylate, vinyl methacrylate, and methyl methacrylate). The degree of living polymerization indicated by n is preferably about 10 to 100, and more preferably about 10 to 30. X may include a structure formed by block polymerization of an acrylic acid resin, a methacryl resin or the like.

X may include halogen or amino. X is preferably halogen, such as fluorine (F), which is water repellent, chemical resistant, and heat resistant, chlorine (Cl), bromine (Br), and iodine (I), which are easy to substitute by using various nucleophilic reagents. Because of the amino group contained in X, nanocellulose can be amidated by a functional carboxylic acid derivative, and becomes an optimal modified nanocellulose for preparing a composite material containing nanocellulose and a resin.

X may include thiol (—SH), sulfide (—SR¹), or disulfide (—SSR²). This is advantageous in that various metal nano particles (e.g., Au) can be adsorbed by chemical bonds, and nanocellulose fibers having a conductive property and a specific light absorbing property can thus be produced. When X includes sulfide (—SR¹), or disulfide (—SSR²), R¹ or R² may be the aforementioned alkylene, alkenylene, alkylene containing an aromatic ring, or alkenylene containing an aromatic ring.

The modified nanocellulose according to the present invention preferably has a structure in which a portion of the hydroxyl groups of cellulose constituting nanocellulose is substituted with a constituent represented by formula (1a).

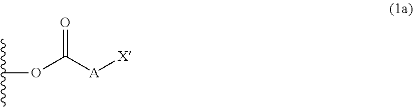

Formula (1a) shows an embodiment of formula (1); i.e., “X represents a group including an alicyclic hydrocarbon group.”

In formula (1a), X′ represents an alicyclic hydrocarbon group.

In formula (1a), A represents a linker (connecting region) between a carbonyl group and an alicyclic hydrocarbon group X′.

A is preferably alkylene, alkenylene, alkylene containing an aromatic ring, alkenylene containing an aromatic ring, cycloalkylene, cycloalkenylene, etc.

A linear or branched alkylene having 1 to 30 carbon atoms (—CₙH₂ₙ—) is preferable. Examples include methylene, ethylene, trimethylene, propylene, 2,2-dimethyl trimethylene, tetramethylen, pentamethylene, and hexamethylene. Alkylene having 1 to 18 carbon atoms is more preferable.

A linear or branched alkenylene having 2 to 30 carbon atoms is preferable. Examples include vinyl(ethenylene), allyl(propenylene), butenylene, pentenylene, and hexenylene. Alkenylene having 6 to 18 carbon atoms is more preferable.

A may further include a divalent aromatic ring. A may be alkylene having a divalent aromatic ring or alkenylene having a divalent aromatic ring. The divalent aromatic ring is a group formed by removing two hydrogen atoms attached to respective carbon atoms constituting the aromatic ring. Examples of aromatic rings include benzene ring (benzene rings), condensed benzene rings (naphthalene ring, pyrene ring, anthracene ring, biphenylene ring, etc.), non-benzene aromatic rings (tropylium ring, cyclopropenium ring, etc.), and heteroaromatic rings (a pyridine ring, pyrimidine ring, pyrrole ring, thiophene ring, etc.).

A may include one or more unsaturated bonds, such as double bonds and triple bonds. A having a double bond as an unsaturated bond has a structural isomer of a cis- or trans-configuration, and both types of structural isomers can be used in the present invention without particular restriction.

X may include a structure formed by living polymerization of an olefinic monomer, styrenic monomer, and/or acrylic monomer (acrylic acid-based monomers, such as acrylic acid, allyl acrylate, ethyl acrylate, and methyl acrylate; and methacrylic acid based monomers, such as methacrylic acid, allyl methacrylate, ethyl methacrylate, glycidyl methacrylate, vinyl methacrylate, and methyl methacrylate). The degree of living polymerization indicated by n is preferably about 10 to 100, and more preferably about 10 to 30. A may include a structure formed by block polymerization of an acrylic acid resin, a methacryl resin, or the like.

A may include halogen or amino. A is preferably halogen, such as fluorine (F), which is water repellent, chemical resistant, and heat resistant, chlorine (Cl), bromine (Br), and iodine (I), which are easy to substitute by using various nucleophilic reagents. Because of the amino group contained in A, nanocellulose can be amidated by a functional carboxylic acid derivative, and becomes an optimal modified nanocellulose for preparing a composite material containing nanocellulose and a resin.

A may include thiol (—SH), sulfide (—SR¹), or disulfide (—SSR²). This is advantageous in that various metal nano particles (e.g., Au) can be adsorbed by chemical bonds, and nanocellulose fibers having a conductive property and a specific light absorbing property can thus be produced. When A includes sulfide (—SR¹), or disulfide (—SSR²), R¹ or R² may be the aforementioned alkylene, alkenylene, alkylene containing an aromatic ring, or alkenylene containing an aromatic ring.

A preferably contains an ether linkage (—O—).

The nanocellulose modified, for example, by bornyl phenoxyacetic acid has a structure in which nanocellulose —O—CO— is followed by an alkylene group (methylene group, etc.), an ether linkage (—O—), a phenylene group, and an alicyclic hydrocarbon group, in that order.

A in formula (1a) preferably has a linker, such as an alkylene group (methylene group, ethylene group, etc.), and —O— (ether linkage, oxygen-containing structure). The modified nanocellulose will have excellent physical properties (elastic modulus, tensile strength, etc.).

In the modified nanocellulose according to the present invention, X in formula (1) is preferably

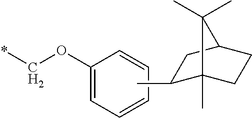

(bornyl phenoxymethyl), or

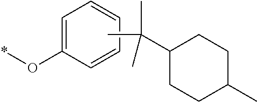

(menthyl phenoxymethyl) for the following reasons: the modified nanocellulose, when combined with a resin, can be highly dispersed in the resin while imparting a significantly high elastic modulus to the composite; cellulose nanofibers are not susceptible to damage because of the mild conditions for conducting a chemical modification reaction; and the modified nanocellulose becomes thermally highly stable. Each group falls within the scope of the above formula (1a). The compound may be in the form of a mixture comprising a p-isomer, an o-isomer, and the like.

X in formula (1) is preferably bornyl phenoxyethyl, bornyl phenoxypropyl, bornyl phenoxybutyl, norbornyl phenoxymethyl, fenchyl phenoxymethyl, menthoxymethyl, isomenthoxy methyl, adamanthyl phenoxymethyl, adamanthyl oxymethyl, dicyclopentanyl oxymethyl, dicyclopentenyl oxymethyl, etc.

As with bornyl phenoxymethyl and the like for X in formula (1), it is preferable that X′ in formula (1a) represent an alicyclic hydrocarbon group and A be bound to nanocellulose via an ester bond (—O—CO—), thereby binding the nanocellulose indirectly to an alicyclic hydrocarbon group.

X in formula (1) preferably includes bornyl, and more preferably includes bornyl and phenoxy.

In the modified nanocellulose according to the present invention, X in formula (1) is preferably

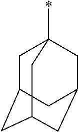 [SMILES: *C12CC3CC(CC(C3)C1)C2]

(adamanthyl) because the modified nanocellulose, when combined with a resin, can be highly dispersed in the resin while imparting a high elastic modulus to the composite.

X in formula (1) is preferably noradamanthyl, norbornenyl, or the like.

In the modified nanocellulose according to the present invention, X in formula (1) is preferably

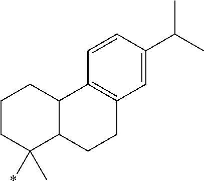 [SMILES: *C1(C)CCCC2c3ccc(C(C)C)cc3CCC21]

(dehydroabietyl) because the modified nanocellulose, when combined with a resin, can be highly dispersed in the resin while imparting a high elastic modulus to the composite.

X in formula (1) is preferably abietyl, or the like.

In the modified nanocellulose according to the present invention, X in formula (1) is preferably

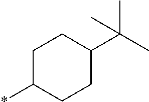 [SMILES: *C1CCC(C(C)(C)C)CC1]

(tert-butyl cyclohexyl) because the modified nanocellulose can be highly dispersed in a resin while imparting a high elastic modulus to the composite.

In the modified nanocellulose according to the present invention, X in formula (1) is preferably

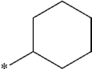 [SMILES: *C1CCCCC1]

(cyclohexyl) because the modified nanocellulose becomes thermally highly stable.

X in formula (1) is preferably cyclo rings, such as cyclopentyl, cycloheptyl, and cyclohexenyl, hydrocarbons (cycloalkene) having a single double bond in a ring, such as cyclopentenyl, and cycloheptenyl, ethylcyclohexyl, methylcyclohexyl, phenyl cyclopentyl, trifluoromethyl cyclohexyl, aminomethyl cyclohexyl, aminocyclohexyl, cyclohexyl substituted with C₁₋₁₈alkoxy, or the like.

The modified nanocellulose according to the present invention has on the surface of the nanocellulose at least one type of functional group selected from the group consisting of functional group X and functional group X′ with linkage A.

Preferable examples of modifying agents for adding the substituent (X of formula (1) or X′ with A of formula (1a)) to nanocellulose include

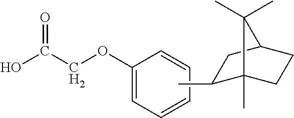

(bornyl phenoxyacetic acid),

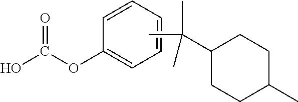

(menthyl phenoxyacetic acid), bornyl phenoxypropanoic acid, bornyl phenoxybutanoic acid, bornyl phenoxypentanoic acid, adamanthyl phenoxyacetic acid, norbornyl phenoxyacetic acid, fenchyl phenoxyacetic acid, menthoxy acetic acid, isomenthoxy acetic acid, adamanthyl acetic acid, dicyclopentanyl oxyacetic acid, and dicyclopentenyl oxyacetic acid. The compounds may be in the form of a mixture comprising a plurality of isomers.

Preferable examples of modifying agents for adding the substituent to nanocellulose include

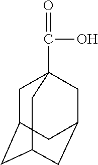 [SMILES: O=C(O)C12CC3CC(CC(C3)C1)C2]

(adamantane carboxylic acid), noradamanthyl carboxylic acid, and norbornyl carboxylic acid.

Preferable examples of modifying agents for adding the substituent to nanocellulose include

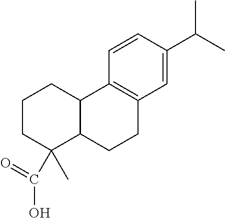 [SMILES: CC(C)c1ccc2c(c1)CCC1C2CCCC1(C)C(=O)O]

(dehydroabietic acid) and abietic acid.

Preferable examples of modifying agents for adding the substituent to nanocellulose include

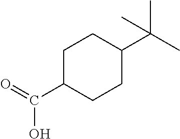

(tert-butylcyclohexane carboxylic acid),

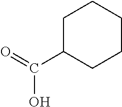

(cyclohexane carboxylic acid), cyclopentane carboxylic acid, cycloheptane carboxylic acid, cyclohexene carboxylic acid, cyclopentene carboxylic acid, cyclohepten carboxylic acid, ethylcyclohexane carboxylic acid, methylcyclohexane carboxylic acid, phenylcyclopentane carboxylic acid, trifluoromethyl cyclohexane carboxylic acid, aminomethylcyclohexane carboxylic acid, aminocyclohexane carboxylic acid, and cyclohexane carboxylic acid substituted with C₁₋₁₈ alkoxy.

The aforementioned carboxylic acid compounds may be compounds in which the hydroxy is substituted with halogen (acid halides such as acid chloride can be used as a modifying agent), alkoxy (alkoxy esters can be used as a modifying agent), or acyloxy (acid anhydrides can be used as a modifying agent).

Nanocellulose has at least one type of functional group represented by formula (1) (the structure comprising functional group X or functional group X′ with linkage A) on its surface.

The degree of substitution (DS) of the ester group of the nanocellulose that has been modified by a modifying agent capable of adding the structure represented by formula (1) may be about 0.8 or less, preferably about 0.5 or less, more preferably about 0.01 to 0.5, and still more preferably about 0.3 to 0.5. Setting the DS to preferably about 0.01 or more, or more preferably about 0.4, minimizes the reaction time and the amount of the reagent for use, while maximizing effects. Setting the DS to about 0.5 or less achieves esterification of almost all hydroxyl groups on the surface of the nanocellulose while preventing the substitution of hydroxyl groups in the crystalline structure inside the nanocellulose, thereby inhibiting the decrease of hydrogen bonding strength. This can inhibit a decrease in the strength of the nanocellulose, and thus produce an expected reinforcing effect. Cellulose has a structure in which a number of D-glucopyranose are β-1,4 linked, and has three hydroxyl groups per structural unit. The degree of reaction progression in substituting hydroxy with ester is defined by the equation: the mean number of hydroxy substituted with other substituent per glucopyranose residue of cellulose—the degree of substitution (DS). The maximum value is three.

DS is determined by removing a modifying agent used as a starting material, and by-products such as hydrolysate of the starting material by washing, and then subjecting the modified nanocellulose to various analysis methods, such as percentage weight gain, elemental analysis, neutralization titration, FT-IR, ¹-NMR, and ¹³C-NMR. In particular, in the modified nanocellulose of the present invention, the reaction can be tracked by constantly measuring the degree of substitution (DS) of the ester group of the product by using infrared (IR) absorption spectra. The DS of the ester group can be determined by the following equation.

DS=0.0113X−0.0122

wherein X is the area of the absorption peak of ester carbonyl near 1,733 cm⁻¹; the spectrum intensity of 1,315 cm⁻¹ has been normalized to 1.

Compounds having an ester group (ester bond) show a strong absorption band associated with the C═O bond near 1,733 cm⁻¹ in infrared (IR) absorption spectra. Thus, measuring the strength of the absorption band quantitatively determines the DS of the ester group. In other words, measuring the absorption band associated with the ester bond determines the DS readily and easily.

The modified nanocellulose having a specific surface area and mean fiber diameter in the same range as that of the aforementioned nanocellulose may be used.

The modified nanocellulose according to the present invention has at least one type of functional group X, which is an alicyclic hydrocarbon group or a group including an alicyclic hydrocarbon group, on the surface of the nanocellulose (CNF, CNC). Thus, the modified nanocellulose is suitable for the surface chemical treatment of nanocellulose. The modified nanocellulose according to the present invention also has a high specific surface area (250 to 300 m²/g), and is lighter and stronger than steel. The modified nanocellulose according to the present invention is also less subject to thermal deformation than glass. Therefore, the modified nanocellulose according to the present invention, which has high strength and low thermal expansion, is useful as a sustainable resource material. For example, it is possible to produce a composite material that has high strength and low thermal expansion by combining the modified nanocellulose of the present invention with a polymeric material such as resin, or a highly functional material by further introducing a functional group into the modified nanocellulose of the present invention.

### 2. Method for Producing Modified Nanocellulose

The method for producing the modified nanocellulose of the present invention enables the production of a modified nanocellulose wherein a portion of the hydroxyl groups of cellulose constituting nanocellulose is substituted with a (at least one) substituent represented by formula (1):

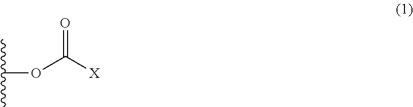

wherein X represents an alicyclic hydrocarbon group or a group including an alicyclic hydrocarbon group, and the method comprises modifying the nanocellulose with a compound represented by formula (2)

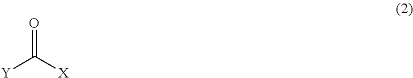

wherein X is as defined above; and Y represents halogen, hydroxy, alkoxy, or acyloxy.

The nanocellulose described in “1. Modified Nanocellulose” can be used as a starting material. Because of its high specific surface area, the use of nanocellulose enables suitable adjustment of the number of substituents to be introduced into the nanocellulose.

The degree of polymerization of natural cellulose is about 500 to 10,000, and that of regenerated cellulose is about 200 to 800. Cellulose is formed by extended-chain crystals in which bundles of β-1,4 linked, linearly extended cellulose fibers are fixed by intramolecular or intermolecular hydrogen bonds. Although X-ray diffraction or solid-state NMR spectroscopy reveals that cellulose crystals have a variety of crystalline structures, natural cellulose has only the type-I crystalline structure. From analysis such as X-ray diffraction, the proportion of the crystalline region in wood pulp cellulose is estimated to be about 50 to 60%, and that of bacterial cellulose is estimated to be higher than that, at about 70%. Because of its extended-chain crystal form, cellulose is not only highly elastic, but also five times stronger than steel, while having a linear thermal expansion coefficient equal to or below 1/50 that of glass. In other words, destroying the crystalline structure of cellulose results in a loss of the excellent characteristics of cellulose, such as a high elastic modulus and high strength.

Cellulose is typically insoluble in commonly used solvents as well as in water. In the prior art, cellulose is dissolved in a mixture solution of dimethylacetamide (DMAc)/LiCl, and subjected to a modification treatment. Dissolving cellulose in this manner causes strong interaction between the solvent components and the hydroxyl groups of cellulose to thereby cleave the intramolecular or intermolecular hydrogen bonds in cellulose. The cleavage of the hydrogen bonds increases the flexibility of the molecular chain, which leads to an enhanced solubility. In other words, dissolution of cellulose means destruction of the cellulose crystalline structure. However, dissolved cellulose, i.e., cellulose that has lost the crystalline structure, cannot exhibit excellent cellulose characteristics, such as a high elastic modulus and high strength. This has been seen in the prior art. Thus, the prior art has great difficulty carrying out a modification treatment on cellulose while maintaining the cellulose crystalline structure.

The modified nanocellulose of the present invention is produced without dissolving the nanocellulose. The modified nanocellulose of the present invention is prepared by modifying nanocellulose while the nanocellulose is dispersed in a solvent; i.e., the modification treatment is conducted in a heterogeneous solution. Conducting a modification treatment without dissolving nanocellulose maintains the type-I cellulose crystalline structure in the nanocellulose, thereby enabling the production of a modified nanocellulose maintaining the aforementioned characteristics, such as high strength and low thermal expansion. In other words, the modified nanocellulose of the present invention maintains the type-I cellulose crystalline structure, and also exhibits characteristics such as high strength and low thermal expansion.

When water is used as a dispersion medium in the step of preparing nanocellulose (the defibration step), it is preferable to replace the dispersion medium with another solvent before modifying the nanocellulose with a modifying agent and to disperse the nanocellulose in the solvent. Such other solvent is preferably an amphiphilic solvent, and examples include ketone-based solvents, such as acetone and methyl ethyl ketone; ester-based solvents, such as ethyl acetate; and polar aprotic solvents, such as n-methyl-2-pyrrolidone (NMP), dimethylformamide (DMF), dimethylacetamide (DMAc), and dimethyl sulfoxide (DMSO). These solvents may be used singly or in a combination of two or more. Of these, NMP is preferable because of the ease of water removal from the system as well as the great ease of CNF dispersion.

X of a modifying agent represented by formula (2) used in the above modification of nanocellulose,

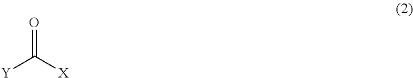

is as defined in “1. Modified Nanocellulose.” X of the modifying agent represents an alicyclic hydrocarbon group or a group including an alicyclic hydrocarbon group.

In the modification of nanocellulose described above, Y of formula (2)

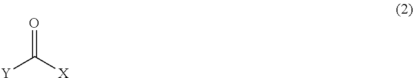

represents halogen, hydroxy, alkoxy, acyloxy, or a common leaving group. In the production method of the modified nanocellulose according to the present invention, Y reacts with a portion of the hydroxyl groups in cellulose constituting nanocellulose to form ester linkage, thereby producing a nanocellulose modified with a (at least one) substituent represented by formula (1).

Because Y is a leaving group, Y is preferably halogen, such as chlorine, bromine, and iodine.

Because Y is a hydroxyl group, a commercially available carboxylic acid can be advantageously used as a reagent.

Because Y is easily removed and highly reactive, Y is preferably alkoxy, such as methoxy, ethoxy, and propoxy.

Because fewer side reactions occur, Y is preferably acyloxy expressed by XCOO in which X is the same as X to be introduced.

Nanocellulose is preferably modified by a compound represented by formula (2a)

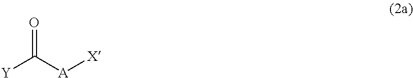

wherein Y is as defined in the above formula (2). Formula (2a) shows, of the scope of formula (2), an embodiment in which X is a group including an alicyclic hydrocarbon group.
In formula (2a), X′ and A are as defined in the above formula (1a).

Of the compounds (modifying agents) represented by formula (2) for modifying nanocellulose according to the present invention, preferable are

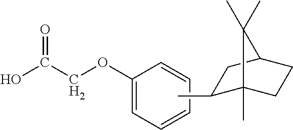

(bornyl phenoxyacetic acid),

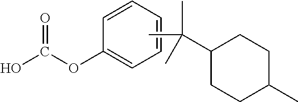

(menthyl phenoxyacetic acid), bornyl phenoxy propanoic acid, bornyl phenoxy butanoic acid, bornyl phenoxy pentanoic acid, adamanthyl phenoxyacetic acid, norbornyl phenoxyacetic acid, fenchyl phenoxyacetic acid, menthoxy acetic acid, isomenthoxy acetic acid, adamanthyl acetic acid, dicyclopentanyl oxyacetic acid, dicyclopentenyl oxyacetic acid, and the like for the following reasons: the compounds, when combined with a resin, can be highly dispersed in the resin while imparting a significantly high elastic modulus to the composite; cellulose nanofibers are not susceptible to damage because of the mild conditions for conducting a chemical modification reaction; and the modified nanocellulose becomes thermally highly stable. The compounds may be in the form of a mixture comprising a plurality of isomers.

Of the compounds represented by formula (2) for modifying nanocellulose according to the present invention, preferable are

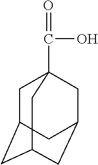 [SMILES: O=C(O)C12CC3CC(CC(C3)C1)C2]

(adamantane carboxylic acid), noradamanthyl carboxylic acid, norbornyl carboxylic acid, and the like because the compounds, when combined with a resin, can be highly dispersed in the resin while imparting a significantly high elastic modulus to the composite.

Of the compounds represented by formula (2) for modifying nanocellulose according to the present invention, preferable are

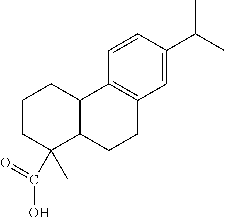 [SMILES: CC(C)c1ccc2c(c1)CCC1C2CCCC1(C)C(=O)O]

(dehydroabietic acid), abietic acid, and the like because the compounds, when combined with a resin, can be highly dispersed in the resin while imparting a high elastic modulus to the composite.

Of the compounds represented by formula (2) for modifying nanocellulose according to the present invention, preferable are

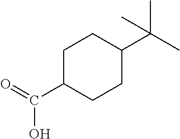

(tert-butylcyclohexane carboxylic acid),

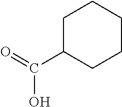

(cyclohexane carboxylic acid), cyclopentane carboxylic acid, cycloheptane carboxylic acid, cyclohexene carboxylic acid, cyclopentene carboxylic acid, cyclohepten carboxylic acid, ethylcyclohexane carboxylic acid, methylcyclohexane carboxylic acid, phenylcyclopentane carboxylic acid, trifluoromethyl cyclohexane carboxylic acid, aminomethyl cyclohexane carboxylic acid, aminocyclohexanecarboxylic acid, cyclohexane carboxylic acid substituted with C₁₋₁₈ alkoxy, and the like for the following reasons: the compounds, when combined with a resin, can be highly dispersed in the resin while imparting a high elastic modulus to the composite; and the modified nanocellulose becomes thermally highly stable.

The aforementioned carboxylic acid compounds may be compounds in which the hydroxy is substituted with halogen (acid halides such as acid chlorides can be used as a modifying agent), alkoxy (alkoxy esters can be used as a modifying agent), or acyloxy (acid anhydrides can be used as a modifying agent).

The above-stated reagents, which are commercially readily available, have moderate stability and reactivity, and can be used as a starting material to introduce other functional groups. Further, the use of such reagents reveals the correlation between the structure and the physical properties of the various derivatives obtained from the reagents.

A reaction between nanocellulose and a modifying agent represented by formula (2) causes substitution of a portion of the hydroxyl groups of cellulose constituting the nanocellulose with the substituent represented by formula (1). In the modification of nanocellulose, the use of one or more types of modifying agents represented by formula (2) produces nanocellulose having one or more types of substituents represented by formula (1) (the structure containing functional group X, or functional group X′ with A represented by formula (1a)) on the surface thereof.

The amount of the modifying agent represented by formula (2) for use in modifying nanocellulose is sufficient as long as the degree of substitution (DS) of the ester group in the modified nanocellulose is within a predetermined range. The amount of the modifying agent for use is preferably about 0.1 to 20 moles, and more preferably about 0.4 to 10 moles, per mole of glucose units contained in nanocellulose.

An excess amount of the modifying agent can be added to nanocellulose to allow the reaction to proceed until a predetermined DS is achieved, and the reaction is then terminated. Alternatively, a minimum amount of the modifying agent can be added, and the reaction time, the temperature, and the amount of the catalyst can be adjusted to allow the reaction to proceed until a predetermined DS is achieved.

The reaction for modifying nanocellulose with the modifying agent can be somewhat carried out by heating without using a catalyst if dehydration is fully performed. However, it is more preferable to use a catalyst because nanocellulose is highly efficiently modified under mild conditions when a catalyst is used.

Examples of catalysts used for modifying nanocellulose include acids, such as hydrochloric acid, sulfuric acid, and acetic acid, and amine-based catalysts. Acid catalysts are typically aqueous solutions, and the addition of such acid catalysts may cause acid hydrolysis of cellulose fibers in addition to esterification. Thus, alkaline catalysts or amine-based catalysts are more preferable.

Specific examples of amine-based catalysts include pyridine-based compounds, such as pyridine and dimethylaminopyridine (DMAP); acyclic amine compounds, such as triethylamine and trimethyl amine; and cyclic tertiary amine compounds, such as diazabicyclo octane. Of these, pyridine, dimethylaminopyridine (DMAP), and diazabicyclo octane are preferable from the standpoint of excellent catalytic activity. A powder of an alkaline compound, such as potassium carbonate and sodium carbonate, may optionally be used as a catalyst, or can be used in combination with an amine-based compound.

The amine-based catalyst can be used in an equimolar amount or more with respect to the modifying agent, and a liquid amine compound, such as pyridine, may be used in an excess amount as a catalyst as well as a solvent. The amount for use is about 0.1 to 40 moles per mole of glucose units of nanocellulose. An excess amount of a catalyst can be added to nanocellulose to allow the reaction to proceed until a predetermined DS is achieved, and the reaction is then terminated. Alternatively, a minimum amount of a catalyst can be added, and the reaction time, the temperature, and the like can be adjusted to allow the reaction to proceed until a predetermined DS is achieved. It is generally preferred to remove the catalyst after the reaction by washing, distillation, or the like.

The nanocellulose modified by the above-described modifying agent preferably has a DS in the numerical range stated above.

Although the modification of nanocellulose accompanied by esterification can be carried out in water, the reaction efficiency is significantly lowered. Thus, modification is preferably carried out in a non-aqueous solvent. Non-aqueous solvents are preferably organic solvents that are not reactive with the modifying agent, and more preferably aprotic solvents. Specific examples of non-aqueous solvents include halogenated solvents, such as methylene chloride, chloroform, and carbon tetrachloride; ketone-based solvents, such as acetone and methyl ethyl ketone (MEK); ester-based solvents, such as ethyl acetate; ether-based solvents, such as dimethyl or diethyl products (ethers), including tetrahydrofuran (THF), ethylene glycol, propylene glycol, and polyethylene glycol; polar aprotic solvents (amide-based solvents), such as dimethylformamide (DMF), dimethylacetamide (DMAc) and N-methylpyrrolidone (NMP); and non-polar solvents, such as hexane, heptane, benzene, and toluene; and mixtures of these solvents. Of these, polar aprotic solvents, such as dimethylformamide (DMF), dimethylacetamide (DMAc), methylpyrrolidone (NMP) and dimethyl sulfoxide (DMSO), are preferable from the standpoint of nanocellulose dispersibility, modifying agent reactivity, and ease of removing the water content from nanocellulose by distillation. It is particularly preferable to use acetone to remove the water content from nanocellulose by solvent replacement before reaction.

When esterifying nanocellulose by the modifying agent, the reaction temperature for modification, although suitably adjusted depending on the modifying agent, is preferably, for example, about 20 to 200° C. The reaction temperature is preferably about 20 to 160° C., more preferably about 30 to 120° C., and still more preferably about 40 to 100° C. A high temperature is preferable because the reaction of nanocellulose becomes more efficient. However, because an excessively high temperature causes partial degradation of nanocellulose, the temperatures within the stated ranges are preferable.

After esterification of nanocellulose by the modifying agent, unreacted modifying agent may be left, or may be removed as necessary. To easily remove the solvent in the subsequent step (the step of mixing modified nanocellulose with a resin component, etc.), the modified nanocellulose may be washed with another solvent to remove the solvent used in the modification step. Examples of solvents used for washing after the modification step include ketone-based solvents, such as acetone and methyl ethyl ketone; alcoholic solvents, such as methanol and ethanol; ester-based solvents, such as ethyl acetate; and polar aprotic solvents, such as NMP, DMF, and DMAc. Of these, alcoholic solvents, such as methanol and ethanol, acetone, methyl ethyl ketone, and ethyl acetate, are preferable because such solvents can be easily removed and the modified nanocellulose can be well dispersed in the solvents.

To increase the specific surface area in the production method of the present invention), the modified nanocellulose may be further defibrated. For defibration, the methods stated above can be used.

### Reaction Between Nanocellulose and Acid Chloride Containing Alicyclic Hydrocarbon Group

A modified nanocellulose can be produced, for example, by preparing a water slurry of nanocellulose, replacing the aqueous solvent with NMP, and reacting the nanocellulose with an acid chloride containing an alicyclic hydrocarbon group (a compound represented by formula (2)) in the presence of a pyridine catalyst. Commercially available acid chlorides can be used. Acid chlorides synthesized separately can also be used. The reaction is terminated when the desired degree of substitution (DS: about 0.4) is achieved, and the reaction mixture is fully washed with acetone and ethanol, followed by solvent replacement with isopropanol. The solvent used in this stage is suitably selected from the above-described solvents depending on the type of modifying agent, taking into consideration the dispersibility of the modified nanocellulose to be produced as well as the dispersibility of nanocellulose.

### Synthesis of Acid Chloride Using Carboxylic Acid and Thionyl Chloride

The above-described acid chloride can be produced by reacting a carboxylic acid containing an alicyclic hydrocarbon group with thionyl chloride or the like in toluene or methylene chloride. Adding a catalytic amount of DMF in this stage efficiently facilitates the reaction.

### (1) Preparation of Nanocellulose

An aqueous dispersion of nanocellulose (cellulose nanofibers (CNF), cellulose nanocrystals (CNC)) is prepared (a suspension of nanocellulose in water, a concentration of about 0.5 to 5% by mass). Subsequently, the suspension of nanocellulose in water is made into a nanocellulose acetone slurry (a suspension of nanocellulose in acetone) by the solvent replacement technique accompanied, for example, by centrifugal separation (addition of acetone, dispersion, centrifugal separation, and removal of the supernatant) (solids content: about 10 to 30% by mass).

### (2) Esterification Reaction of Nanocellulose

2 to 7 g of the suspension of nanocellulose in acetone (solids content: 10 to 30% by mass, nanocellulose net weight: 0.2 to 2.1 g, anhydroglucose residue: 1.23 to 13.0 mM) is placed in a distillation flask, and suspended in 50 to 200 mL of a polar aprotic solvent (dehydrated NMP, etc.) and 25 to 100 mL of toluene. The suspension is heated in an oil bath of 140 to 180° C., and the acetone and toluene are distilled off while the remaining water content of nanocellulose is simultaneously removed. The obtained suspension of the dehydrated nanocellulose in the polar aprotic solvent (NMP, etc.) is cooled to 0° C., and 0.01 to 6 g of a dehydrated pyridine (0.1 to 75 mM), and 0.05 to 8 g of the compound represented by formula (2) (esterifying reagent) are added dropwise in series. For example, adamantane carboxylic acid chloride can be added in an amount of about 0.01 to 37 mM as the compound represented by formula (2). The reaction liquid is heated to 40 to 60° C., and esterification is started. The following describes the outline of the reaction.

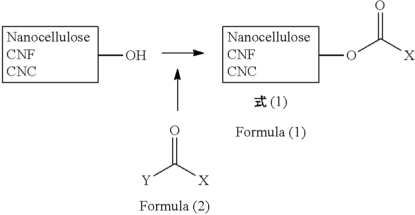

In the reaction, X and Y are as defined above.

The degree of substitution (DS) of the ester group of the product is constantly measured with infrared absorption spectroscopy to track the reaction.

The DS of the ester group is calculated by using the following equation.

DS=0.0113X−0.0122

wherein X is the area of the absorption peak of ester carbonyl near 1,733 cm⁻¹. The spectrum intensity of 1,315 cm⁻¹ has been normalized to 1.

The DS may be about 0.8 or less. When the DS reaches about 0.5 or about 0.4, the reaction suspension is diluted with 100 to 400 mL of ethanol, and subjected to centrifugation at 2,500 to 10,000 rpm for 5 to 30 minutes (repeated about three times), followed by removal of the remaining modifying agent and polar aprotic solvent (NMP, etc.), and finally replacement with a solvent such as acetone. The DS increases along with the reaction time. When the DS reaches 0.87, the X-ray diffraction peaks of type-I cellulose crystals in natural cellulose (1-10), (110), and (200) become broad. When the DS reaches 1.29 and 1.92, the peaks completely disappear, and a new broad peak appears near 2θ 19°. To maintain the characteristics of the material, it is essential to maintain the type-I crystals. Thus, it is preferable to adjust the DS to preferably about 0.8, more preferably about 0.5, still more preferably about 0.4, and particularly more preferably about 0.4 to 0.5. The preferable lower limit of the DS is about 0.01. The same results are observed in an SEM image. Along with the increase of the DS, the shape of the fibers is deformed, and the shape is completely lost at a DS of 1.92, thereby becoming a uniform film.

After the replacement with acetone, a suspension of the modified nanocellulose in acetone (solids content: about 10 to 30% by mass) can be obtained. For example, when adamantane carboxylic acid is used as the compound represented by formula (2), adamantane carboxylic acid nanocellulose is produced as the compound represented by formula (1). The yield is about 90 to 98% by mass. The DS of the product is determined by infrared absorption spectroscopy, and also determined by quantifying the carboxylic acid detached through ester hydrolysis.

### 3. Resin Composition Containing Modified Nanocellulose

A resin component can be added to the modified nanocellulose of the present invention to produce a resin composition.

The resin composition according to the present invention comprises: a modified nanocellulose (A) in which a portion of the hydroxyl groups of cellulose constituting nanocellulose are substituted with a (at least one) substituent represented by formula (1)

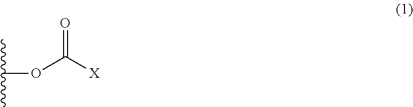

wherein X represents an alicyclic hydrocarbon group or a group including an alicyclic hydrocarbon group; and a resin (B).

For the modified nanocellulose, the modified nanocellulose described in “1. Modified Nanocellulose” and the modified nanocellulose prepared in “2. Method for Producing Modified Nanocellulose” can be used.

The resin component is not particularly limited. Examples include thermoplastic resins and thermosetting resins.

Because of the ease of molding, thermoplastic resins are preferably used as the resin component. Examples of thermoplastic resins include olefin-based resins, nylon resins, polyamide-based resins, polycarbonate-based resins, polysulfone-based resins, polyester-based resins, and cellulose-based resins, such as triacetylcellulose and diacetylcellulose. Examples of polyamide-based resins include polyamide 6 (PA6, ring-opened polymer of ε-caprolactam), polyamide 66 (PA66, polyhexamethylene adipamide), polyamide 11 (PA11, a polyamide obtained by ring-opening polycondensation of undecanelactam), and polyamide 12 (PA12, a polyamide obtained by ring-opening polycondensation of lauryl lactam).

The thermoplastic resin is preferably an olefin-based resin because the resin composition thereof can fully obtain reinforcing effects, and olefin-based resins are inexpensive. Examples of olefin-based resins include polyethylene-based resins, polypropylene-based resins, vinyl chloride resins, styrene resins, (meth)acrylic resins, and vinyl ether resins. These thermoplastic resins may be used singly, or in a combination of two or more as a resin mixture. Of these olefin-based resins, polyethylene-based resins (PE), such as high-density polyethylene (HDPE), low-density polyethylene (LDPE), and biopolyethylene, polypropylene-based resins (PP), vinyl chloride resins, styrene resins, (meth)acrylic resins, and vinyl ether resins are preferable because the resin composition thereof can fully obtain reinforcing effects, and these olefin-based resins are inexpensive.

Thermosetting resins, such as epoxy resins, phenol resins, urea resins, melamine resins, unsaturated polyester resins, diallyl phthalate resins, polyurethane resins, silicon resins, and polyimide resins, may also be used. These thermosetting resins may be used singly or in a combination of two or more.

As a compatibilizer, a resin obtained by adding maleic anhydride, epoxy, or the like, to a thermoplastic or thermosetting resin to thereby introduce a polar group (e.g., maleic anhydride modified polyethylene resin, and maleic anhydride modified polypropylene resin) and various commercially available compatibilizers may be used in combination. These resins may be used singly or in a combination of two or more as a resin mixture. In the use of a resin mixture containing two or more such resins, a maleic anhydride modified resin and other polyolefin-based resin may be used in combination.

When a resin mixture of a maleic anhydride modified resin and another polyolefin-based resin is used, the thermoplastic or thermosetting resin (A) contains a maleic anhydride modified resin preferably in an amount of about 1 to 40% by mass, and more preferably about 1 to 20% by mass. Specific examples of resin mixtures include mixtures of a maleic anhydride modified polypropylene-based resin and a polyethylene resin or a polypropylene resin, and mixtures of a maleic anhydride modified polyethylene resin and a polyethylene resin or a polypropylene resin.

In addition to the components stated above, the resin composition may comprise the following additives: for example, compatibilizers; surfactants; polysaccharides, such as starch and alginic acid; natural proteins, such as gelatin, glue, and casein; inorganic compounds, such as tannin, zeolite, ceramics, and metal powder; colorants; plasticizers; flavoring agents; pigments; flow regulating agents; leveling agents; conducting agents; antistatic agents; UV absorbers; UV dispersers; and deodorants.

Such optional additives can be contained in an amount to the extent that the effect of the present invention is not impaired. For example, the resin composition comprises an optional additive in an amount of preferably about 10% by mass or less, and more preferably about 5% by mass or less.

It is sufficient as long as the amount of the modified nanocellulose, calculated as the nanocellulose (the nanocellulose content of the modified nanocellulose), achieves physical properties required of a resin composition containing the modified nanocellulose. About 0.5 parts by mass of the modified nanocellulose, calculated as the nanocellulose (the nanocellulose content of the modified nanocellulose), per 100 parts by mass of the resin can produce a reinforcing effect attributable to the nanocellulose. About 0.5 parts by mass or more of the modified nanocellulose, calculated as the nanocellulose (the nanocellulose content of the modified nanocellulose), can produce an even higher reinforcing effect. When water resistance is required of a molded article obtained from the resin composition, it is preferable that the modified nanocellulose, calculated as the nanocellulose (the nanocellulose content of the modified nanocellulose), be contained in an amount of about 150 parts by mass or less.

The resin composition according to the present invention comprises a resin as a matrix. Thus, to increase the compatibility of nanocellulose and resin at the interface, it is preferable to use a modified nanocellulose in which a functional group that is highly compatible with the resin is introduced into the nanocellulose. Specifically, it is preferable to use a modified nanocellulose into which an alicyclic hydrocarbon group is introduced.

The obtained modified nanocellulose is combined with a resin to produce a molding material, and a molded article (molded product) can be produced from the molding material. The molded article containing the resin obtained by using the modified nanocellulose has a higher tensile strength and elastic modulus than molded articles containing only a resin, or molded articles obtained by combining unmodified nanocellulose with a resin.

The resin composition according to the present invention comprises a modified nanocellulose (A) and a resin (B), in which the resin (B) in the resin composition is in the form of lamellae that are layered in a direction different from the fiber length direction of the modified nanocellulose (A) (FIG. 9).

The resin composition comprises fibrous cores of the resin (B) that are uniaxially oriented in the fiber length direction of the modified nanocellulose (A), and the lamellae of the resin (B) are layered between the modified nanocellulose (A) and the fibrous cores in a direction different from the fiber length direction of the modified nanocellulose W. Because of the lamellar formation of the resin component in the resin composition, the resin composition is believed to show increased strength (FIG. 9).

The above-described structure is described as a shish kebab structure (shish kabab structure) formed by a combination of a modified nanocellulose (A) and a resin (B). The structure is so named because it resembles a Turkish, skewered roasted meat (shish is skewer, and kebab is meat). In the shish kebab structure of the present invention, the shish part is the extensile fibers of the modified nanocellulose (A), and the kebab part is the lamellae of the resin (B) (lamellar crystals, folded configuration) (FIG. 9). Because of the shish kebab structure formed by a modified nanocellulose (A) and a resin (B), the resin composition (molding material, molded article) has a higher tensile strength and elastic modulus.

### 4. Method for Producing Resin Composition Containing Modified Nanocellulose

The resin composition according to the present invention can be produced by the following production method. A method for producing a resin composition comprising: a modified nanocellulose (A) wherein a portion of the hydroxyl groups of cellulose constituting nanocellulose is substituted with a (at least one) substituent represented by formula (1)

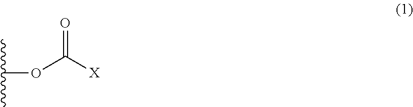

wherein X represents an alicyclic hydrocarbon group or a group including an alicyclic hydrocarbon group; and a resin (B), the method comprising: step 1 of modifying nanocellulose with a compound represented by formula (2)

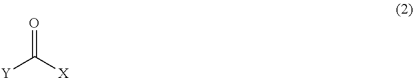

wherein X is as defined above; and Y represents halogen, hydroxy, alkoxy, or acyloxy, to thereby substitute a portion of the hydroxyl groups of cellulose constituting nanocellulose with a (at least one) substituent represented by formula (1)

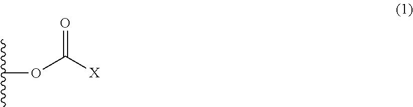

wherein X is as defined above; and step 2 of combining the modified nanocellulose obtained in step 1 with a resin (B).

For the nanocellulose of step 1, the nanocellulose described in “1. Modified Nanocellulose” and “2. Method for Producing Modified Nanocellulose” can be used to prepare a modified nanocellulose. For the modifying agent, the modifying agent described in “2. Method for Producing Modified Nanocellulose” can be used.

For the resin component (B) of step 2, the resin component described in “3. Resin Composition Containing Modified Nanocellulose” can be used. The amount of the modified nanocellulose with respect to the resin component may be determined so as to become the amount described in “3. Resin Composition Containing Modified Nanocellulose.”

The resin composition (composite material) according to the present invention can be prepared by combining the modified nanocellulose (A) with the resin (B). The resin (B) component may react with the functional group (functional group X in formula (1)) of the modified nanocellulose (A) by chemical binding, or the like. All of, or a portion of, the functional groups in the modified nanocellulose (A) may react with the resin (B).

Examples of methods for combining a modified nanocellulose with a resin component (optionally with an additive) include kneading methods using a mixer, such as a bench roll, a Banbury mixer, a kneader, and a planetary mixer; mixing methods using an agitating blade; and mixing methods using a revolution or rotation agitator.

The temperature for mixing is not particularly limited as long as the curing agent reacts with the resin, and no inconvenience is caused in mixing. The modified nanocellulose may be combined with the resin component at room temperature without heating, or with heating. When mixing is performed with heating, the mixing temperature is preferably about 40° C. or more, more preferably about 50° C. or more, and still more preferably about 60° C. or more. At the mixing temperature of about 40° C. or more, the modified nanocellulose can be uniformly combined with the resin component, and the resin component can be reacted with functional group X of the modified nanocellulose.

In step 2, an additive may optionally be added. The above-listed additives may be used.

Because the modified nanocellulose (A) is modified with a (at least one) substituent represented by formula (1)

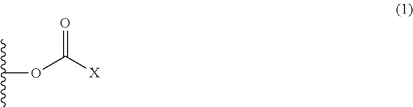

wherein X is an alicyclic hydrocarbon group or a group including an alicyclic hydrocarbon group, the modified nanocellulose (A) is easily mixed with the resin (B) in the resin composition. In traditionally used resin compositions, highly hydrophilic conventional modified nanocellulose is mixed poorly with highly hydrophobic plastic resin (PP, PE, etc.). In the resin composition according to the present invention, the modified nanocellulose (A) is excellently dispersed in the resin (B) (dispersion medium). The molding materials, or molded articles produced by using the resin composition have high strength and elastic modulus.

The resin composition (molding materials, molded articles) produced by the above production method has high tensile strength and elastic modulus because of the shish kebab structure formed by the modified nanocellulose (A) and the resin (B). The extensile fibers of the modified nanocellulose (A) correspond to the shish part, and the lamellae (lamellar crystals, folded configuration) of the resin (B) correspond to the kebab part.

### 5. Molding Material and Molded Article

The present invention enables preparation of a molding material using the above-described resin composition. The resin composition can be molded into a desired shape, and used as a molding material. The molding material can be, for example, in the form of sheets, pellets, and powder. Molding materials in such shapes can be obtained by using a technique such as compression molding, injection molding, extrusion molding, hollow molding, and foam molding.

The present invention enables molding the molding material into a molded article. The molding conditions for resin can be suitably adjusted to be applied to the molding of the molding material as necessary. The molded article according to the present invention can be used not only in the field of fiber-reinforced plastics where nanocellulose-containing resin molded articles are used but also in fields where higher mechanical strength (tensile strength, etc.) is required. The molding material and molded article can be effectively used, for example, in interior materials, exterior materials, and structural materials of automobiles, electric trains, marine vessels, and airplanes; cases, structural materials, and inner parts of electric appliances, such as personal computers, televisions, telephones, and clocks; cases, structural materials, and inner parts of mobile communication equipment such as mobile phones; cases, structural materials, and inner parts of portable music reproduction equipment, image reproduction equipment, printing equipment, copy machines, and sporting goods; building materials; and business equipment, cases, and containers, such as stationery.

Because a portion of the hydroxyl groups of cellulose constituting nanocellulose is substituted with a (at least one) substituent represented by formula (1), the modified nanocellulose of the present invention is suitable for surface modification of nanocellulose and introduction of one or more functional groups into nanocellulose without losing the characteristics of the nanocellulose as a material (high strength, low thermal expansion). Because of the high reactivity between the modified nanocellulose and a resin, and high adhesion strength at the interface, the resin composition containing the modified nanocellulose represented by formula (1) can fully have a reinforcing effect attributable to the nanocellulose content, thereby having enhanced bending strength.

### EXAMPLES

Hereinafter, Examples and Comparative Examples describe the present invention in more detail. However, the invention is not limited to these Examples.

### Example 1

### 1. Preparation of Nanocellulose (CNF)

600 g of needle bleached kraft pulp (NBKP, refiner-treated, Oji Paper Co., Ltd., solids content: 25%) was added to 19.94 kg of water to prepare an aqueous suspension (an aqueous suspension having a pulp slurry concentration of 0.75% by weight). The obtained slurry was mechanically defibrated using a bead mill (NVM-2, manufactured by Aimex Co., Ltd.) (zirconia bead diameter: 1 mm, loading amount of beads: 70%, engine speed: 2,000 rpm, and processing cycles: 2).

### 2. Production of CNF Acetone Slurry

100 g of the CNF aqueous suspension prepared in the above section “1. Preparation of Nanocellulose (CNF)” was placed in respective centrifuge tubes, and centrifuged at 7,000 rpm for 20 minutes, followed by removal of the supernatants, thereby giving precipitates. 100 g of acetone was added to each of the centrifuge tubes, and stirred well to disperse the precipitates (the CNF) in the acetone, followed by centrifugation to remove the supernatants, thereby giving precipitates. This procedure (addition of acetone, dispersion, centrifugation, and removal of the supernatant) was repeated two more times, thereby giving a CNF acetone slurry having a solids content of 5% by mass.

### 3. Synthesis of Modifying Agent

### Synthesis Example 1

### Synthesis of Bornyl Phenoxyacetic Acid

54 g of bornyl phenol (YS resin CP, manufactured by Yasuhara Chemical Co. Ltd.), 83 g of potassium carbonate, 28 mL of methyl bromoacetate, 3.3 g of potassium iodide, and 700 mL of acetone were placed in a 1-L four-necked flask equipped with a stirring blade, and refluxed for 5 hours, followed by filtration to remove the solids content. Subsequently, the acetone was distilled off, and 150 mL of a 2N aqueous solution of sodium hydroxide and 300 mL of ethyl alcohol were added thereto. The mixture was subjected to reaction for 5 hours. 150 mL of a 2N aqueous solution of hydrochloric acid, 200 mL of water, and 200 mL of ethyl acetate were added to the reaction mixture, and extraction was performed, followed by solvent distillation, thereby giving a white solid substance, which was 67 g of bornyl phenoxyacetic acid.

### Synthesis Example 2

### Synthesis of Menthyl Phenoxyacetic Acid

### Synthesis of Menthyl Phenol

74 g of phenol was placed in a 1-L four-necked flask equipped with a stirring blade, and heated to 180° C. in a nitrogen atmosphere while 7 g of aluminum was gradually added thereto. Subsequently, the mixture was cooled to 40° C., and then 24 g of phenol, 40 g of (−)-menthol, and again 24 g of aluminum were added thereto, followed by heating to 180° C. to subject the mixture to a reaction for 6 hours. The reaction mixture was cooled to room temperature, and then 200 mL of ethyl acetate and 100 mL of concentrated hydrochloric acid were added thereto, followed by stirring for 12 hours. The stirred mixture was filtrated, and 800 mL of a 5% aqueous solution of sodium hydroxide was added to the filtrate, followed by extraction with ethyl acetate. The phenol was distilled off, thereby giving 34 g of menthyl phenol.

### Synthesis of Menthyl Phenoxyacetic Acid

23 g of menthyl phenol, 42 g of potassium carbonate, 14 mL of methyl bromoacetate, 1.7 g of potassium iodide, and 250 mL of acetone were placed in a 1-L four-necked flask equipped with a stirring blade, and refluxed for 5 hours, followed by filtration to remove the solids content. Subsequently, the acetone was distilled off, and 75 mL of a 2N aqueous solution of sodium hydroxide and 150 mL of ethyl alcohol were added thereto. The mixture was subjected to a reaction for 5 hours. 75 mL of a 2N aqueous solution of hydrochloric acid, 100 mL of water, and 100 mL of ethyl acetate were added to the reaction mixture, and extraction was performed, followed by solvent distillation, thereby giving an oily substance, which was 30 g of menthyl phenoxyacetic acid.

### Synthesis Example 3

### Synthesis of Bornyl Phenoxyacetic Acid

### Chloride

50 g of bornyl phenoxyacetic acid, 13 mL of thionyl chloride (1.1 equivalents per equivalent of the carboxylic acid), 0.1 mL of dimethylformamide, and 700 mL of toluene were added to a 1-L four-necked flask equipped with a stirring blade, and subjected to a reaction at room temperature for one hour. Toluene and thionyl chloride were distilled off under reduced pressure, thereby giving an oily substance, which was 55 g of bornyl phenoxyacetic acid chloride.

### 4. Esterification of CNF

The CNF acetone slurry obtained in section “2. Production of CNF Acetone Slurry” was placed in a 1-L four-necked flask equipped with a stirring blade (5 g on a solids basis). 500 mL of N-methyl-2-pyrrolidone (NMP) and 250 mL of toluene were added thereto, followed by stirring to disperse CNF in the mixture of NMP and toluene. A condenser was attached to the flask, and the dispersion was heated to 150° C. in a nitrogen atmosphere to distill off the acetone and water contained in the dispersion together with toluene. Subsequently, the dispersion was cooled to 40° C., and then 15 mL of pyridine (2 equivalents per equivalent of the CNF hydroxyl group) and 25 g of bornyl phenoxyacetic acid chloride (modifying agent, esterifying reagent):

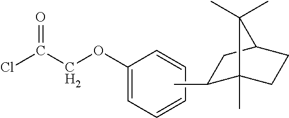

(1 equivalent per equivalent of the CNF hydroxyl group) were added thereto. The mixture was subjected to a reaction in a nitrogen atmosphere for 90 minutes, thereby giving an esterification-modified CNF (bornyl phenoxyacetic acid CNF). Bornyl phenoxyacetic acid chloride is a mixture comprising a p-isomer and an o-isomer.

The degree of substitution (DS) of the ester group in the obtained product was constantly measured by infrared absorption spectroscopy to track the reaction (Note 1). In this example, after 90 minutes from the point at which the DS reached about 0.4 (Note 2), the reaction suspension was diluted with 200 mL of ethanol, and centrifuged at 7,000 rpm for 20 minutes, followed by removal of the supernatant, thereby giving a precipitate. This procedure (addition of ethanol, dispersion, centrifugation, and removal of the supernatant) was repeated by using acetone in place of ethanol. Further, this procedure was repeated two times by using NMP in place of acetone, thereby giving an esterification-modified CNF slurry.

Note 1: The DS of the ester group was calculated by using the following equation.

DS=0.0113X−0.0122

wherein X represents the absorption peak area of ester carbonyl near 1,733 cm⁻¹; the spectrum intensity of 1,315 cm⁻¹ has been normalized to 1.)
Note 2: DS increased along with the reaction time.

### 5. Production of Resin Composition

The esterification-modified CNF slurry obtained in section “4. Esterification of CNF” calculated to give the CNF content of 15 g was stirred under reduced pressure using a Trimix (manufactured by Inoue MFG., Inc) and dried. A polypropylene (PP) resin (Novatec MA-04A, manufactured by Japan Polypropylene Corporation) calculated to give a total solids content of 150 g was added thereto, and kneaded under the following conditions, followed by pelletization, thereby giving a resin composition.
Extruder: “TWX-15” manufactured by Technovel Corporation
Kneading Conditions: Temperature=180° C.
   Discharge=600 g/H
   Screw rotation speed=200 rpm

### 6. Production of Resin Molded Article

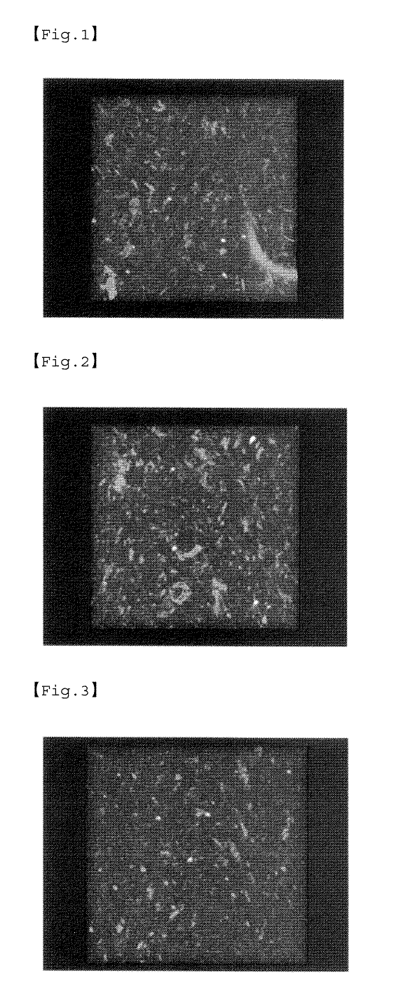

The resin composition obtained in section “5. Production of Resin Composition” was molded by injection under the following conditions to thereby prepare test specimens (bornyl phenoxyacetic acid CNF-PP molded article, FIG. 1).
Injection Molding Machine: “NP7” manufactured by Nissei Plastic Industrial Co., Ltd.
Molding Conditions: Molding Temperature=190° C.
   Mold Tool Temperature=40° C.
   Injection Rate=50 cm³/second

The elastic modulus and tensile strength of each of the obtained specimens were measured by using an electromechanical universal testing machine (manufactured by Instron) at a testing rate of 1.5 mm/min (load cell 5 kN). The support span was 4.5 cm.

### Example 2

The procedure described in Example 1 was repeated except that adamantane carboxylic acid (modifying agent, esterifying reagent):

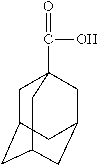 [SMILES: O=C(O)C12CC3CC(CC(C3)C1)C2]

(1 equivalent per equivalent of CNF hydroxyl group) was used in place of the bornyl phenoxyacetic acid of Example 1 to produce esterification-modified CNF (adamantane carboxylic acid CNF), a resin composition, and a resin molded article (adamantane carboxylic acid CNF-PP molded article) (FIG. 2). The elastic modulus and tensile strength were evaluated.

### Example 3

The procedure described in Example 1 was repeated except that dehydroabietic acid (modifying agent, esterifying reagent):

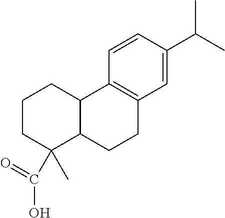 [SMILES: CC(C)c1ccc2c(c1)CCC1C2CCCC1(C)C(=O)O]

(1 equivalent per equivalent of CNF hydroxyl group) was used in place of the bornyl phenoxyacetic acid of Example 1 to produce esterification-modified CNF (dehydroabietic acid CNF), a resin composition, and a resin molded article (dehydroabietic acid CNF-PP molded article) (FIG. 3). The elastic modulus and tensile strength were evaluated.

### Example 4

The procedure described in Example 1 was repeated except that tert-butylcyclohexane carboxylic acid (modifying agent, esterifying reagent):

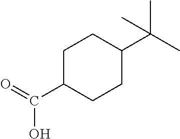

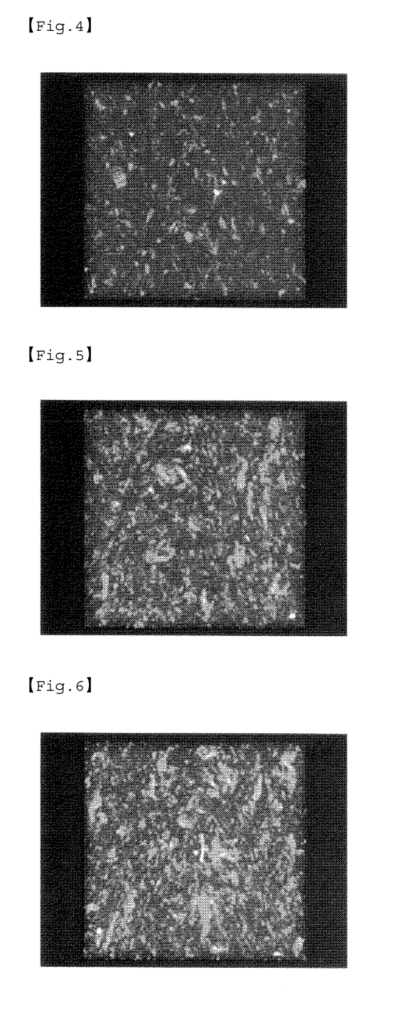

(1 equivalent per equivalent of CNF hydroxyl group) was used in place of the bornyl phenoxyacetic acid of Example 1 to produce esterification-modified CNF (tert-butylcyclohexane carboxylic acid CNF), a resin composition, and a resin molded article (tert-butylcyclohexane carboxylic acid CNF-PP molded article) (FIG. 4). The elastic modulus and tensile strength were evaluated.

### Example 5

The procedure described in Example 1 was repeated except that cyclohexane carboxylic acid (modifying agent, esterifying reagent):

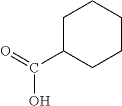

(1 equivalent per equivalent of CNF hydroxyl group) was used in place of the bornyl phenoxyacetic acid of Example 1 to produce esterification-modified CNF (cyclohexane carboxylic acid CNF), a resin composition, and a resin molded article (cyclohexane carboxylic acid CNF-PP molded article) (FIG. 5). The elastic modulus and tensile strength were evaluated.

### Example 6

The procedure described in Example 1 was repeated except that menthyl phenoxyacetic acid (modifying agent, esterifying reagent):

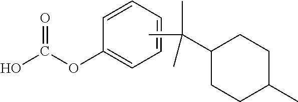

(1 equivalent per equivalent of CNF hydroxyl group) was used in place of the bornyl phenoxyacetic acid of Example 1 to produce esterification-modified CNF (menthyl phenoxyacetic acid CNF), a resin composition, and a resin molded article (menthyl phenoxyacetic acid CNF-PP molded article). The elastic modulus and tensile strength were evaluated. Menthyl phenoxyacetic acid is a mixture comprising a p-isomer and an o-isomer.

### Comparative Example 1

The procedure described in Example 1 was repeated except that an unmodified CNF was used to produce a PP resin composition and a PP resin molded article. The elastic modulus and tensile strength were evaluated. The elastic modulus was 2.38 Gpa, and the tensile strength was 38.3 Mpa.

### Comparative Example 2

A resin composition of PP and a resin molded article of PP were produced, and the elastic modulus was evaluated. The elastic modulus was 1.83 Gpa.

The resin molded articles produced in Examples 1 to 6 (the resin molded articles formed of a resin composition comprising PP and CNF modified with alicyclic hydrocarbon group or a group containing an alicyclic hydrocarbon group) showed a higher elastic modulus and tensile strength than those of the resin molded article of Comparative Example 1 (the resin molded article formed of a resin composition comprising unmodified CNF and PP) and the resin molded article of Comparative Example 2 (the resin molded article formed of a resin composition comprising only PP).

### Example 7

The procedure described in Example 1 was repeated using the esterification-modified CNF (bornyl phenoxyacetic acid CNF) produced in Example 1 except that polyethylene (PE) resin (Suntec HD J-320 manufactured by Asahi Kasei Chemicals Corporation) was used in place of PP under the following conditions: the temperature for kneading was 140° C., and the temperature for molding was 160° C. to produce a resin composition and a resin molded article (bornyl phenoxyacetic acid CNF-PE molded article) (FIGS. 7 and 9). The elastic modulus and tensile strength were evaluated.

### Example 8

The procedure described in Example 7 was repeated except that adamantane carboxylic acid (modifying agent, esterifying reagent: 1 equivalent per equivalent of CNF hydroxyl group) was used in place of the bornyl phenoxyacetic acid of Example 7 to produce an esterification-modified CNF (adamantane carboxylic acid CNF), a resin composition and a resin molded article (adamantane carboxylic acid CNF-PE molded article). The elastic modulus and tensile strength were evaluated.

### Example 9

The procedure described in Example 7 was repeated except that tert-butylcyclohexane carboxylic acid (modifying agent, esterifying reagent: 1 equivalent per equivalent of CNF hydroxyl group) was used in place of the bornyl phenoxyacetic acid of Example 7 to produce an esterification-modified CNF (tert-butylcyclohexane carboxylic acid CNF), a resin composition and a resin molded article (tert-butylcyclohexane carboxylic acid CNF-PE molded article). The elastic modulus and tensile strength were evaluated.

### Example 10

The procedure described in Example 7 was repeated except that cyclohexane carboxylic acid (modifying agent, esterifying reagent: 1 equivalent per equivalent of CNF hydroxyl group) was used in place of the bornyl phenoxyacetic acid of Example 7 to produce an esterification-modified CNF (cyclohexane carboxylic acid CNF), a resin composition and a resin molded article (cyclohexane carboxylic acid CNF-PE molded article). The elastic modulus and tensile strength were evaluated.

### Comparative Example 3

The procedure described in Example 7 was repeated except that an unmodified CNF was used to produce a PE resin composition and a PE resin molded article. The elastic modulus and tensile strength were evaluated. The elastic modulus was 1.47 Gpa and the tensile strength was 34.2 Mpa.

### Comparative Example 4

A resin composition of PE and a resin molded article of PE were produced, and the elastic modulus and tensile strength were evaluated. The elastic modulus was 1.06 Gpa and the tensile strength was 21.6 Mpa.

The resin molded articles produced in Examples 7 to 10 (the resin molded articles formed of a resin composition comprising PE and CNF modified with an alicyclic hydrocarbon group or a group including an alicyclic hydrocarbon group) showed a higher elastic modulus and tensile strength than those of the resin molded article of Comparative Example 3 (the resin molded article formed of a resin composition comprising an unmodified CNF and PE) and the resin molded article of Comparative Example 4 (the resin molded article formed of a resin composition comprising only PE).

The CNFs chemically modified with an alicyclic hydrocarbon group or a group including an alicyclic hydrocarbon group were excellently dispersed in the resins (thermoplastic resins, such as PP and PE). The CNFs chemically modified with a group containing an alicyclic hydrocarbon group were excellently adhered to the resins at the interface. Consequently, the resin molded articles formed of resins and the CNFs chemically modified with an alicyclic hydrocarbon group or a group including an alicyclic hydrocarbon group showed excellent elastic modulus and tensile strength. This effect was more remarkable in the CNF chemically modified with bornyl phenoxyacetic acid and menthyl phenoxyacetic acid, which are alicyclic hydrocarbon groups having a linker.

The procedure described in Example 1 was repeated except that myristic acid (modifying agent, esterifying reagent: 1 equivalent per equivalent of CNF hydroxyl group) was used in place of bornyl phenoxyacetic acid of Example 1 to produce an esterification-modified CNF (myristoyl CNF), a resin composition (PP) and a resin molded article. The elastic modulus was evaluated. The elastic modulus of the resin molded article (PP) containing the myristoyl CNF was 2.27 Gpa.

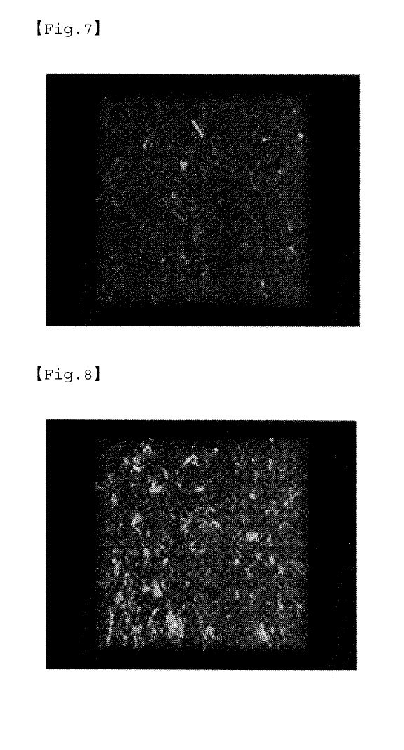

The procedure described in Example 1 was repeated except that pivalic acid (modifying agent, esterifying reagent: 1 equivalent per equivalent of CNF hydroxyl group) was used in place of bornyl phenoxyacetic acid of Example 1 to produce an esterification-modified CNF (pivaloyl CNF), a resin composition (PP) and a resin molded article (FIG. 6). The dispersibility of the pivaloyl CNF in the PP resin composition was not satisfactory.

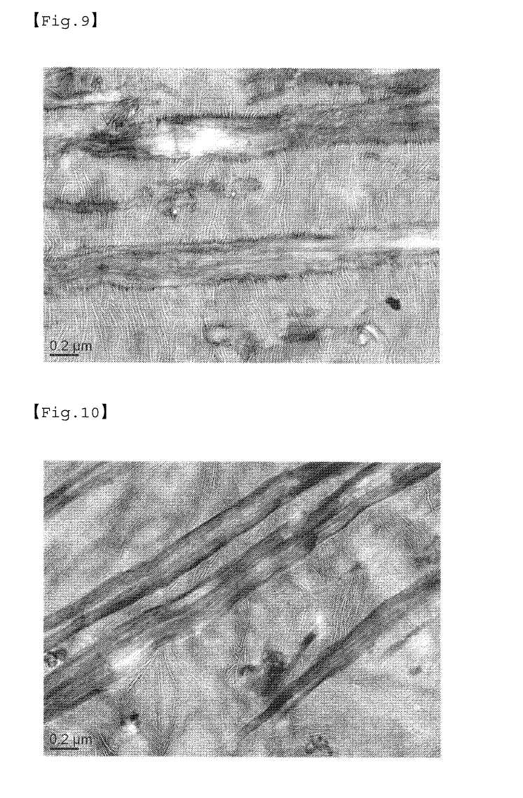

The procedure described in Example 7 was repeated except that acetic acid (modifying agent, esterifying reagent: 1 equivalent per equivalent of CNF hydroxyl group) was used in place of bornyl phenoxyacetic acid of Example 7 to produce an esterification-modified CNF (acetyl CNF), a resin composition (PE) and a resin molded article (FIG. 8). The elastic modulus and the tensile strength were evaluated. The elastic modulus and the tensile strength of the resin molded article (PE) containing the acetyl CNF were 1.69 Gpa and 39.6 Mpa, respectively.

The procedure described in Example 7 was repeated except that myristic acid (modifying agent, esterifying reagent: 1 equivalent per equivalent of CNF hydroxyl group) was used in place of bornyl phenoxyacetic acid of Example 7 to produce an esterification-modified CNF (myristoyl CNF), a resin composition (PE) and a resin molded article (FIG. 10). The elastic modulus was evaluated. The elastic modulus of the resin molded article (PE) containing the myristoyl CNF was 2.25 Gpa.

The procedure described in Example 7 was repeated except that stearic acid (modifying agent, esterifying reagent: 1 equivalent per equivalent of CNF hydroxyl group) was used in place of bornyl phenoxyacetic acid of Example 7 to produce an esterification-modified CNF (stearoyl CNF), a resin composition (PE) and a resin molded article. The elastic modulus and the tensile strength were evaluated. The elastic modulus of the resin molded article (PE) containing the stearoyl CNF was 1.94 Gpa.

The resin molded articles, to which a CNF modified with a fatty acid or a higher fatty acid had been added, showed a higher elastic modulus than the resin molded article consisting of PP or the resin modified article consisting of PE. However, the CNFs modified with a fatty acid or a higher fatty acid were not well dispersed in resins (thermoplastic resins such as PP and PE). The CNFs modified with a fatty acid or a higher fatty acid were poorly adhered to the resins at the interface.

FIG. 9 shows a TEM observation image of the resin molded article obtained in Example 7 (bornyl phenoxyacetic acid CNF-PE). The observation revealed that the resin molded article of Example 7 contains lamellae of PE, and the lamellae are regularly layered in a direction different from the fiber length direction of bornyl phenoxyacetic acid CNF. Specifically, crystalline lamellae of PE are vertically grown from the surface of the bornyl phenoxyacetic acid CNF in the resin molded article of Example 7. Further, in the resin molded article of Example 7, fibrous cores of PE that are uniaxially oriented in the fiber length direction of the bornyl phenoxyacetic acid CNF are formed, and the lamellae of PE are layered between the bornyl phenoxyacetic acid CNF and the fibrous cores in a direction different from the fiber length direction of the bornyl phenoxyacetic acid CNF. The combination of bornyl phenoxyacetic acid CNF and PE has formed a shish-kebab structure (shish-kabab structure). In this shish-kebab structure, the shish part is the extensile fibers of the bornyl phenoxyacetic acid CNF, and the kebab part is the lamellae of PE (lamellar crystals, folded configuration) (FIG. 9). Because of the shish-kebab structure formed by bornyl phenoxyacetic acid CNF and PE, the resin composition (molding material, molded article) showed higher tensile strength and elastic modulus. It is likely that the lamellae formation contributes largely to increasing resin reinforcement.

FIG. 10 shows a TEM observation image of the resin molded article (myristoyl CNF-PE molded article) obtained by using myristic acid in place of the bornyl phenoxyacetic acid of Example 7. Unlike the bornyl phenoxyacetic acid CNF-PE, the lamellar formation is not sufficient, and the lamellae are layered in random directions.

TABLE 1

| | | | | CNF Content in | Elastic Modulus | Tensile Strength |
|---|---|---|---|---|---|---|
| | Modifying Agent Used for | | Resin | Resin Composition | of Resin Molded | of Resin Molded |
| | Preparing Modified CNF | DS | Component | (% by mass) | Article (GPa) | Article (MPa) |
| Example 1 | Bomyl phenoxyacetic acid | 0.4 | PP | 10 | 3.61 | 50.0 |
| Example 2 | Adamantane carboxylic acid | 0.39 | PP | 10 | 3.37 | 48.7 |
| Example 3 | Dehydroabietic acid | 0.39 | PP | 10 | 3.14 | 41.3 |
| Example 4 | tert-Butylcyclohexane carboxylic acid | 0.41 | PP | 10 | 3.08 | 50.5 |
| Example 5 | Cyclohexane carboxylic acid | 0.43 | PP | 10 | 2.62 | 44.3 |
| Example 6 | Menthyl phenoxyacetic acid | 0.41 | PP | 10 | 3.40 | 48.1 |
| Example 7 | Bomyl phenoxyacetic acid | 0.42 | PE | 10 | 3.11 | 50.1 |
| Example 8 | Adamantane carboxylic acid | 0.40 | PE | 10 | 2.38 | 46.7 |
| Example 9 | tert-Butylcyclohexane carboxylic acid | 0.43 | PE | 10 | 2.74 | 48.2 |
| Example 10 | Cyclohexane carboxylic acid | 0.42 | PE | 10 | 2.46 | 47.2 |

1. A modified nanocellulose wherein a portion of the hydroxyl groups of cellulose constituting nanocellulose is substituted with a substituent represented by formula (1): 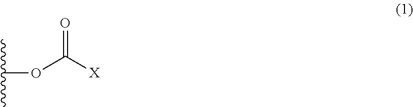
wherein X represents an alicyclic hydrocarbon group or a group including an alicyclic hydrocarbon group.

2. The modified nanocellulose according to claim 1, which has a degree of ester substitution of 0.5 or less.

3. A resin composition comprising:
a modified nanocellulose (A) wherein a portion of the hydroxyl groups of cellulose constituting nanocellulose is substituted with a substituent represented by formula (1) 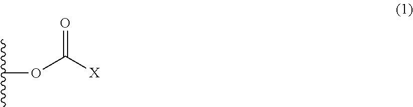
wherein X represents an alicyclic hydrocarbon group or a group including an alicyclic hydrocarbon group; and a resin (B).

4. The resin composition according to claim 3, wherein the amount of the modified nanocellulose, calculated as the nanocellulose, is 0.5 to 150 parts by mass, per 100 parts by mass of the resin (B).

5. The resin composition according to claim 3 wherein the resin (B) is a thermoplastic resin.

6. A resin composition comprising:
a modified nanocellulose (A) wherein a portion of the hydroxyl groups of cellulose constituting nanocellulose is substituted with a substituent represented by formula (1) 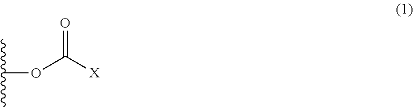
wherein X represents an alicyclic hydrocarbon group or a group including an alicyclic hydrocarbon group; and
a resin (B), the resin (B) in the resin composition being in the form of lamellae that are layered in a direction different from the fiber length direction of the modified nanocellulose (A).

7. The resin composition according to claim 6, comprising fibrous cores of the resin (B) that are uniaxially oriented in the fiber length direction of the modified nanocellulose (A), wherein the lamellae of the resin (B) are layered between the modified nanocellulose (A) and the fibrous cores in a direction different from the fiber length direction of the modified nanocellulose (A).

8. A resin molding material comprising the resin composition according to claim 3.

9. A resin molded article obtained by molding the resin molding material according to claim 8.

10. A method for producing a modified nanocellulose wherein a portion of the hydroxyl groups of cellulose constituting nanocellulose is substituted with a substituent represented by formula (1) 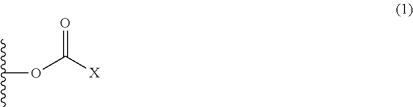
wherein X represents an alicyclic hydrocarbon group or a group including an alicyclic hydrocarbon group, the method comprising modifying nanocellulose with a compound represented by formula (2) 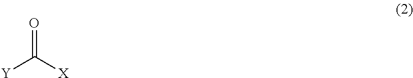
wherein X is as defined above; and Y represents halogen, hydroxy, alkoxy, or acyloxy.

11. The resin composition according to claim 4 wherein the resin (B) is a thermoplastic resin.

12. A resin molding material comprising the resin composition according to claim 4.

13. A resin molding material comprising the resin composition according to claim 5.

14. A resin molding material comprising the resin composition according to claim 6.

15. A resin molding material comprising the resin composition according to claim 7.

16. A resin molding material comprising the resin composition according to claim 11.

17. A resin molded article obtained by molding the resin molding material according to claim 12.

18. A resin molded article obtained by molding the resin molding material according to claim 13.

19. A resin molded article obtained by molding the resin molding material according to claim 14.

20. A resin molded article obtained by molding the resin molding material according to claim 15.
